(19) United States
(12) Patent Application Publication
(10) Pub. No.: US 2022/0144984 A1
(43) Pub. Date: May 12, 2022

(54) Process For The Preparation of Polypropylene

(71) Applicant: Basell Poliolefine Italia S.r.l., Milano (IT)

(72) Inventor: Diego Brita, Ferrara (IT)

(73) Assignee: Basell Poliolefine Italia S.r.l., Milano (IT)

(21) Appl. No.: 17/602,027

(22) PCT Filed: Apr. 1, 2020
(86) PCT No.: PCT/EP2020/059299

§ 371 Date: Oct. 7, 2021

(30) Foreign Application Priority Data
Apr. 11, 2019 (EP) 19168680.7

(51) Int. Cl. C08F 110/06; C08K 5/3417; C08K 3/34; C08K 3/04

(52) U.S. Cl. CPC C08F 110/06; C08K 5/3417; C08K 2003/343; C08K 3/04; C08K 3/34

(57) ABSTRACT

A process for the preparation of a propylene polymer containing a coloring agent, including the steps of:

(i) forming a solid mixture (a-b)of (a) a ZN catalyst component made from or containing Mg, Ti, halogen and an internal electron donor compound, and (b) a coloring agent made from or containing at least a pigment; wherein the mixture being in a weight ratio (b):(a) ranging from 0.01:1 to 0.4:1; and

(ii) feeding the mixture (a-b) to a polymerization reactor and operating the reactor under polymerization conditions to produce the propylene polymer.

wherein the process having the b:a weight ratio and a time in days elapsed between mixture formation and use in polymerization fall below the curve defined by the equation y=3+0.832x^{-1,17} wherein y is the time in days elapsed between mixture formation and use in polymerization and x is the (b):(a) weight ratio.

### FIELD OF THE INVENTION

In general, the present disclosure relates to the field of chemistry. More specifically, the present disclosure relates to polymer chemistry. In particular, the present disclosure relates to a polymerization process for the preparation of a propylene polymer.

### BACKGROUND OF THE INVENTION

In some instances, polyolefins are prepared into articles, using an additive package. In some instances, the additive package is made from or containing stabilizers, clarifying agents, and coloring agents.

In some instances, the additive package is added in the form of an “additive package” pre-blend, further made from or containing antioxidants, acid scavengers, slip agents, light stabilizers, optical brighteners, or UV light absorbers.

In some instances, the coloring agent is in the form of a masterbatch pre-mixed with polymer. Sometimes, the coloring agent is added during or just prior to the forming process. In some instances, a colorant loading of 500-1000 parts per million (ppm) is mixed and dispersed into a plastic in this manner.

In some instances, dispersing an additive into a polymer is made through several steps of successive dilutions. In some instances, the loading level of the additive is in a range of a few ppm.

### SUMMARY OF THE INVENTION

In a general embodiment, the present disclosure provides a process for the preparation of a propylene polymer containing a coloring agent, including the steps of:

(i) forming a solid mixture (a-b) of (a) a ZN catalyst component made from or containing Mg, Ti, halogen and an internal electron donor compound, and (b) a coloring agent made from or containing at least a pigment; wherein the mixture being in a weight ratio (b):(a) ranging from 0.01:1 to 0.4:1; and

(ii) feeding the mixture (a-b) to a polymerization reactor and operating the reactor under polymerization conditions to produce the propylene polymer,

wherein the process having the b:a weight ratio and a time in days elapsed between mixture formation and use in polymerization fall below the curve defined by the equation y=3+0.832x^{-1,17} wherein y is the time in days elapsed between mixture formation and use in polymerization and x is the (b):(a) weight ratio.

In some embodiments, the ZN solid catalyst component a) is of granular, spheroidal irregular or spherical regular morphology. In some embodiments, the ZN solid catalyst component a) has a spherical regular morphology.

In some embodiments, the granular or otherwise irregular catalyst particle is obtained by reacting Ti-halides with precursors of the formula MgXₙ(OR)₂₋ₙ wherein X is Cl or a C₁-C₁₀ hydrocarbon group, R is a C₁-C₈ alkyl group and n ranges from 0 to 2. In some embodiments, a reaction generates solid particles made from or containing MgCl₂ on which a Ti compound is fixed.

In some embodiments, catalyst components having a regular morphology are obtained by reacting Ti-halides with precursors made from or containing adducts of formula MgCl₂(R¹OH)ₙ where R¹ is a C₁-C₈ alkyl group, alternatively ethyl, and n is from 2 to 6.

In some embodiments, the amount of Mg in the solid catalyst component ranges from 8 to 30%, alternatively from 10 to 25% wt, with respect to the total weight of solid catalyst component.

In some embodiments, the amount of Ti ranges from 0.5 to 8% by weight, alternatively from 0.7 to 5% wt, alternatively from 1 to 3.5% wt, with respect to the total weight of solid catalyst component.

In some embodiments, the titanium atoms are part of titanium compounds of formula Ti(OR²)ₙX₄₋ₙ wherein n is between 0 and 4; X is halogen and R² is a hydrocarbon radical, alternatively alkyl, radical having 1-10 carbon atoms. In some embodiments, the titanium compounds have at least one Ti-halogen bond such as titanium tetrahalides or halogenalcoholates. In some embodiments, the titanium compounds are selected from the group consisting of TiCl₄ and Ti(OEt)Cl₃.

In some embodiments, the catalyst component is further made from or containing an electron donor compound (internal donor). In some embodiments, the electron donor compound is selected from esters, ethers, amines, silanes, carbamates and ketones or mixtures thereof.

In some embodiments, the internal donor is selected from the group consisting of alkyl and aryl esters of optionally substituted aromatic mono or polycarboxylic acids and esters of aliphatic acids selected from the group consisting of malonic, glutaric, maleic and succinic acids. In some embodiments, the esters of optionally substituted aromatic mono or polycarboxylic acids are selected from the group consisting of esters of benzoic and phthalic acids. In some embodiments, the internal donors are esters selected from the group consisting of n-butylphthalate, di-isobutylphthalate, di-n-octylphthalate, ethyl-benzoate and p-ethoxy ethyl-benzoate. In some embodiments, the internal donors are selected from the diesters described in Patent Cooperation Treaty Publication No. WO2010/078494 and U.S. Pat. No. 7,388,061. In some embodiments, the internal donors are selected from the group consisting of 2,4-pentanediol dibenzoate derivatives and 3-methyl-5-t-butyl catechol dibenzoates. In some embodiments, the internal donor is a diol derivative selected from the group consisting of dicarbamates, monoesters monocarbamates and monoesters monocarbonates. In some embodiments, the internal donors are selected from the group consisting of 1,3 diethers of the formula:

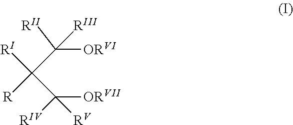

wherein R, R^{I}, R^{II}, R^{III}, R^{IV} and R^{V} equal or different to each other, are hydrogen or hydrocarbon radicals having from 1 to 18 carbon atoms, and R^{VI} and R^{VII}, equal or different from each other, have the same meaning of R-R^{V} except that R^{VI} and R^{VII} cannot be hydrogen. In some embodiments, one or more of the R-R^{VII} groups are linked to form a cycle. In some embodiments, the 1,3-diethers have R^{VI} and R^{VII} selected from C₁-C₄ alkyl radicals.

In some embodiments, mixtures of the donors are used. In some embodiments, the mixtures are made from or containing esters of succinic acids and 1,3-diethers as described in Patent Cooperation Treaty Publication WO2011/061134.

In some embodiments, the internal donors are selected from the group consisting of 1,3 diethers of the formula:

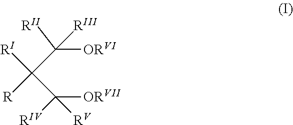

where R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups equal or different from each other, have the same meaning of R^{III} except that R^{IV} groups cannot be hydrogen. In some embodiments, the C₁-C₁₈ hydrocarbon groups of R^{I} and R^{II} form one or more cyclic structures. In some embodiments, each of R^{I} to R^{IV} groups contain heteroatoms selected from halogens, N, O, S and Si.

In some embodiments, the final amount of electron donor compound in the solid catalyst component ranges from 0.5 to 30% by weight, alternatively from 1 to 20% by weight.

In some embodiments, the preparation of the solid catalyst component includes the reaction between magnesium alcoholates or chloroalcoholates and an excess of TiCl₄ in the presence of the electron donor compounds at a temperature of about 80 to 120° C. In some embodiments, the chloroalcoholates are prepared according to U.S. Pat. No. 4,220,554.

In some embodiments, the solid catalyst component is prepared by reacting a titanium compound of formula Ti(OR²)m-yXy, where m is the valence of titanium and y is a number between 1 and m and R² has the same meaning as previously disclosed herein, with a magnesium chloride deriving from an adduct of formula MgCl₂·pR³OH, where p is a number between 0.1 and 6, alternatively from 2 to 3.5, and R³ is a hydrocarbon radical having 1-18 carbon atoms. In some embodiments, the titanium compound is TiCl₄. In some embodiments, the adduct is prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. In some embodiments, the procedure for the preparation of the spherical adducts is as disclosed in U.S. Pat. Nos. 4,399,054 and 4,469,648. In some embodiments, the adduct is directly reacted with Ti compound or subjected to thermal controlled dealcoholation (at a temperature in a range of about 80-130° C.), thereby obtaining an adduct in which the number of moles of alcohol is lower than 3, alternatively between 0.1 and 2.5. In some embodiments, the reaction with the Ti compound is carried out by suspending the adduct (dealcoholated or as such) in cold TiCl₄; the mixture is heated up to 80-130° C. and kept at this temperature for 0.5-2 hours. In some embodiments, the temperature of the cold TiCl₄ is about 0° C. In some embodiments, the treatment with TiCl₄ is carried out one or more times. In some embodiments, the electron donor compound is added during the treatment with TiCl₄. In some embodiments, the preparation of catalyst components in spherical form occurs as described in European Patent Applications EP-A-395083, EP-A-553805, EP-A-553806, EPA601525, or Patent Cooperation Treaty Publication No. WO98/44009.

In some embodiments, the coloring agent b) is made from or containing at least one pigment. In some embodiments, the coloring agent is a mixture made from or containing a dye. In some embodiments, the coloring agent is made from containing a dye in combination with one or more pigments.

In some embodiments, the pigment is either organic or inorganic. As described herein, an organic pigment contains at least a C—H bond. Conversely and as described herein, an inorganic pigment does not contain C—H bonds.

In some embodiments, pigments are black or blue.

In some embodiments, pigments are based on Carbon Black, phthalocyanine metal derivatives, Ultramarine Blue (inorganic), or quinacridone based pigments. In some embodiments, the carbon black is Cabot Black. In some embodiments, the phthalocyanine metal derivative is Cu-phtalocyanine.

In some embodiments, the coloring agent is used in step (i) in amount such that the weight ratio coloring agent b)/catalyst component a) ranges from 0.01:1 to 0.30:1, alternatively from 0.01:1 to 0.25:1, alternatively from 0.01:1 to 0.20:1.

In some embodiments, the solid catalyst component a) and the coloring agent b) are mixed while preventing the contact of the components with contaminants such as oxygen and water.

In some embodiments, the solid dry mixture is prepared using a first closed device equipped with internal rotating structures or a second closed rotating device wherein components a) and b) are mixed without the use of a liquid medium. In some embodiments, the internal rotating structures of the first closed device is a mechanical stirrer.

In some embodiments, the mixing time ranges from 5 minutes to 24 hours, alternatively from 30 minutes to 4 hours. In some embodiments, the mixing temperature is not close to the melting or degradation points of the solids a) and b). In some embodiments, the mixing temperature ranges between 0 and 80° C. In some embodiments, the mixing occurs at room temperature (about 23° C. to about 25° C.).

In some embodiments and after mixing, the solid mixture is used immediately in polymerization. In some embodiments and after mixing, the solid mixture is stored for a period of time, respecting the equation y=3+0.832x^{-1,17} wherein y is the time in days elapsed between mixture formation and use in polymerization and x is the (b):(a) weight ratio.

In some embodiments and in step (i), the weight ratio (b):(a) ranges from 0.01:1 to 0.25:1 and, in step (ii), the mixture (a-b) is fed to the polymerization reactor within a maximum number of days ranging from 7 to 65.

In some embodiments, the activity of the solid catalyst mixture (a-b) expressed as Kg polymer/g mixture fed is lower than that of the component (a) alone. In some embodiments, the activity of component (a) alone ranges from 30 to 100 Kg polymer/g catalyst. It is believed that the lower activity of the mixtures is at least partially due to the dilution effect provided by the pigment. Therefore and considering this dilution effect, the polymerization activity of the solid mixture is referred to the amount of component (a) of the mixture. In some embodiments, the coloring agent accelerates aging of the catalyst. It is believed that if, for a given weight ratio, the time elapsed from preparation to use exceeds the value given by the equation, the catalyst performances are degraded, thereby lowering the catalyst's activity and impacting plant productivity. In some embodiments, the propylene polymers have an amount of coloring agent ranging from 0.2 to 15, alternatively from 0.3 to 10 ppm, alternatively from 0.3 to 8 ppm, referred to the weight of propylene polymer. In some embodiments, these propylene polymers are used to produce objects having a yellowness index lower than comparable objects made from or containing a polymer not containing the coloring agent. It is believed that, when the final amount of coloring agent adversely affects catalyst activity and imparts coloration of the polymer, the amount of coloring agent is too high. It is further believed that the above equation ensures catalyst activity, proper final amount of coloring agent, and polymer properties. In some embodiments, the polymer properties are stereoregularity or bulk density.

In some embodiments, the solid mixture is used in polymerization together with an aluminum alkyl cocatalyst and, optionally, an external electron donor compound.

In some embodiments, the alkyl-Al compound is a trialkyl aluminum compound. In some embodiments, the trialkyl aluminum compound is selected from the group consisting of triethylaluminum, tri-n-hexylaluminum, and tri-n-octylaluminum. In some embodiments, the alkyl-Al compound is selected from mixtures of trialkylaluminums with alkylaluminum halides, alkylaluminum hydrides or alkylaluminum sesquichlorides. In some embodiments, the alkylaluminum sesquichlorides is AlEt₂Cl or Al₂Et₃Cl₃.

In some embodiments, the external electron-donor compounds are selected from the group consisting of silicon compounds, ethers, esters, amines, heterocyclic compounds, ketones and the 1,3-diethers. In some embodiments, the ester is ethyl 4-ethoxybenzoate. In some embodiments, the heterocyclic compound is 2,2,6,6-tetramethyl piperidine. In some embodiments, the external donor compounds are silicon compounds of formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms. In some embodiments, the external electron-donor compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane and 1,1,1,trifluoropropyl-methyl-dimethoxysilane. In some embodiments, the external electron donor compound is used in an amount to give a molar ratio between the organo-aluminum compound and the electron donor compound of from 5 to 500, alternatively from 7 to 400, alternatively from 10 to 200.

In some embodiments, a prepolymerization step is carried out before the main polymerization step. In some embodiments, the prepolymerization step is carried out in a first reactor selected from a loop reactor or a continuously stirred tank reactor. In some embodiments, the prepolymerization is carried out either in gas-phase or in liquid-phase. In some embodiments, the prepolymerization is carried out in liquid-phase. The liquid medium is made from or containing liquid alpha-olefin monomer(s), optionally with the addition of an inert hydrocarbon solvent. In some embodiments, the hydrocarbon solvent is either aromatic or aliphatic. In some embodiments, the aromatic hydrocarbon solvent is toluene. In some embodiments, the aliphatic hydrocarbon solvent is selected from the group consisting of propane, hexane, heptane, isobutane, cyclohexane and 2,2,4-trimethylpentane. In some embodiments, the amount of hydrocarbon solvent is lower than 40% by weight with respect to the total amount of alpha-olefins, alternatively lower than 20% by weight. In some embodiments, the pre-polymerization step is carried out in the absence of inert hydrocarbon solvents.

In some embodiments, the average residence time in the reactor ranges from 2 to 40 minutes, alternatively from 10 to 25 minutes. In some embodiments, the temperature ranges from 10° C. to 50° C., alternatively from 20° C. to 40° C. In some embodiments, the pre-polymerization degree is in the range from 60 to 800 g per gram of solid catalyst component, alternatively from 150 to 500 g per gram of solid catalyst component.

The slurry containing the prepolymerized catalyst is discharged from the pre-polymerization reactor and fed to the reactor where the main polymerization step takes place.

In some embodiments, the main polymerization stage is carried out in gas-phase or in liquid phase. In some embodiments, the gas-phase process is carried out in a fluidized or stirred, fixed bed reactor or in a gas-phase reactor having two interconnected polymerization zones. The first polymerization zone works under fast fluidization conditions. In the second polymerization zone, the polymer flows under the action of gravity. In some embodiments, the liquid phase process is in slurry, solution or bulk (liquid monomer). In some embodiments, the liquid phase process is carried out in continuous stirred tank reactors, loop reactors or plug-flow reactors. In some embodiments, the polymerization is carried out at temperature of from 20 to 120° C., alternatively from 40 to 85° C. In some embodiments, the polymerization is carried out in gas-phase and the operating pressure ranges between 0.5 and 10 MPa, alternatively between 1 and 5 MPa. In some embodiments, the polymerization is carried out in bulk polymerization and the operating pressure ranges between 1 and 6 MPa, alternatively between 1.5 and 4 MPa. In some embodiments, the main polymerization stage is carried out by polymerizing in liquid monomer propylene, optionally in mixture with ethylene and/or C₄-C₁₀ alpha olefins, thereby obtaining crystalline propylene polymer. In some embodiments, the reactor is a loop reactor.

In some embodiments, hydrogen is used as a molecular weight regulator. In some embodiments, the propylene polymer obtained in this stage has a xylene insolubility higher than 90%, alternatively higher than 95%, an isotactic index in terms of content of isotactic pentads (determined with C¹³-NMR on the whole polymer) higher than 93%, alternatively higher than 95%. In some embodiments, the Melt Flow Rate value according to ISO 1133 (230° C., 2.16 Kg) varies within a wide range going from 0.01 to 300 g/10 min, alternatively from 0.1 250 g/10 min. In some embodiments, the polymer bulk density ranges from 0.40 to 0.50 g/cm³.

In case of production of heterophasic propylene copolymers (also called impact copolymers), a second polymerization stage in a different reactor is carried out for the preparation of a propylene/ethylene copolymer. In some embodiments, the second stage is carried out in a fluidized-bed gas-phase reactor in the presence of the polymeric material and the catalyst system coming from the preceding polymerization step. The polymerization mixture is discharged from the first reactor to a gas-solid separator, and subsequently fed to the fluidized-bed gas-phase reactor.

In some embodiments, the polymer produced in this second stage is an ethylene copolymer containing from 15 to 75% wt of a C₃-C₁₀ alpha olefin, optionally containing minor proportions of a diene, being for at least 60% soluble in xylene at room temperature. In some embodiments, the alpha olefin is selected from propylene or butene-1. In some embodiments, the alpha olefin content ranges from 20 to 70% wt.

In some embodiments, the final propylene polymer is obtained as reactor grade with a Melt Flow Rate value according to ISO 1133 (230° C., 2.16 Kg) ranging from 0.01 to 100 g/10 min, alternatively from 0.1 to 70, alternatively from 0.2 to 60. In some embodiments, the final propylene polymer is chemically degraded, thereby achieving the final MFR value.

In some embodiments, the propylene polymers are further made from or containing additives. In some embodiments, the additives are selected from the group consisting of antioxidants, light stabilizers, heat stabilizers, clarifying agents and nucleating agents.

In some embodiments, the addition of nucleating agents improves physical-mechanical properties. In some the physical-mechanical properties are selected from the group consisting of Tensile Modulus, tensile strength at yield, and transparency. In some embodiments, the Tensile Modulus ranges from 800 to 1800 MPa. In some embodiments, the tensile strength at yield ranges from 20 to 50 MPa.

In some embodiments, the nucleating agents are selected from the group consisting of p-tert.-butyl benzoate, dibenzylidene sorbitol derivatives and talc.

In some embodiments, the nucleating agents are added to the compositions in quantities ranging from 0.05 to 2% by weight, alternatively from 0.1 to 1% by weight, with respect to the total weight. In some embodiments, the effect of nucleation is seen by the increase of the crystallization temperature of the polymer. In some embodiments, the coloring agent provides the same effect. In some embodiments, Cu-phthalocyanine, used as coloring agent, has a nucleating effect by increasing the crystallization temperature to 120°-125° C.

In some embodiments, clarifying agents are selected from dibenzylidene sorbitol derivatives.

In some embodiments, the dibenzylidene sorbitol derivatives are in particulate form. In some embodiments, the dibenzylidene sorbitol derivative is 1,3-O-2,4-bis(3,4-dimethylbenzylidene) sorbitol. In some embodiments, the dibenzylidene sorbitol derivatives have other groups substituted on the sorbitol portion of the molecule, or upon the benzene ring portion of the molecule. In some embodiments, the clarifying agent compound is aluminum bis[2,2′-methylene-bis-(4,6-di-tertbutylphenyl) phosphate].

In some embodiments, the polymers are used in the preparation of finished articles. In some embodiments, the techniques are selected from the group consisting of injection molding, extrusion blow molding, injection stretch blow molding and thermoforming.

### EXAMPLES

The data of the propylene polymer materials were obtained according to the following methods:

### Xylene-Soluble Faction

2.5 g of polymer and 250 mL of o-xylene were introduced into a glass flask equipped with a refrigerator and a magnetic stirrer. The temperature was raised in 30 minutes up to the boiling point of the solvent. The resulting solution was then kept under reflux and stirring for further 30 minutes. The closed flask was then kept for 30 minutes in a bath of ice and water and in thermostatic water bath at 25° C. for 30 minutes as well. The resulting solid was filtered on quick filtering paper, and the filtered liquid was divided into two 100 ml aliquots. One 100 ml aliquot of the filtered liquid was poured in a pre-weighed aluminum container, which was heated on a heating plate under nitrogen flow, to remove the solvent by evaporation. The container was then kept in an oven at 80° C. under vacuum until a constant weight was obtained. The residue was weighed to determine the percentage of xylene-soluble polymer.

### Melt Flow Rate (MFR)

Determined according to ISO 1133 (230° C., 2.16 Kg)

### Yellowness Index

The determination of the yellowness index (YI) was obtained by directly measuring the X, Y and Z tristimulus coordinates on pellets using a tristimulus colorimeter capable of assessing the deviation of an object color from a pre-set standard white towards yellow in a dominant wavelength range between 570 and 580 nm. The geometric characteristics of the apparatus allowed perpendicular viewing of the light reflected by two light rays that hit the specimen at 45°, at an angle of 90° to each other, coming from a “Source C” according to CIE standard. After calibration, the glass container was filled with the pellets to be tested and the X, Y, Z coordinates were obtained to calculate the yellowness index according to the following equation:

$$Y I = 100 * ( 1.274 \; 976795 * X - 1.058398178 * Z ) / Y$$

### EXAMPLES

### General Procedure for the Polymerization of Propylene

A 4-liter steel autoclave equipped with a stirrer, pressure gauge, thermometer, catalyst feeding system, monomer feeding lines and thermostatic jacket, was purged with a nitrogen flow at 70° C. for one hour. A suspension containing 75 ml of anhydrous hexane, 0.6 g of triethyl aluminum (AlEt₃, 5.3 mmol) and 0.006 to 0.010 g of solid catalyst component, pre-contacted for 5 minutes with 10 wt % of total AlEt₃ and an amount of dicyclopentyldimethoxysilane, thereby providing a molar ratio between Al/dicyclopentyldimethoxysilane of 20 in a glass-pot, was charged. The autoclave was closed, and hydrogen was added (4500 cc). Then, under stirring, 1.2 kg of liquid propylene was fed. The temperature was raised to 70° C. in about 10 minutes and the polymerization was carried out at this temperature for 2 hours. At the end of the polymerization, the non-reacted propylene was removed; the polymer was recovered and dried at 70° C. under vacuum for 3 hours. The resulting polymer was weighed and characterized.

### General Procedure for the Preparation of MgCl2·(EtOH)m Adducts.

An amount of microspheroidal MgCl₂·2.8C₂H₅OH was prepared according to the method described in Example 2 of U.S. Pat. No. 4,399,054. The resulting adduct had an average particle size of 25 μm.

### Example 1 (Comparative)

Preparation of a 9,9-bis(methoxymethyl)fluorene Containing Solid Catalyst Component.

Into a 2.0 L round bottom glass reactor, equipped with mechanical stirrer, cooler and thermometer, 1.0 L of TiCl₄ was introduced at room temperature under a nitrogen atmosphere. After cooling to −5° C., while stirring, 13.2 g of microspheroidal complex of MgCl₂ and EtOH were introduced. The temperature was then raised from −5° C. to 40° C., and, when this temperature was reached, an amount of 9,9-bis(methoxymethyl)fluorene, used as an internal electron donor, was introduced, thereby producing a Mg/9,9-bis(methoxymethyl)fluorene molar ratio of 6.

At the end of the addition, the temperature was increased to 100° C. and maintained at this value for 30 minutes. Thereafter, stirring was stopped, and the solid product settled. Then the supernatant liquid was siphoned off, leaving a fixed residual volume in the reactor of 300 cm³, while maintaining the temperature at 75° C. After the supernatant was removed, fresh TiCl₄ and an additional amount of donor were added, thereby providing a Mg/9,9-bis(methoxymethyl)fluorene molar ratio of 20. The whole slurry mixture was then heated at 109° C. and kept at this temperature for 30 minutes. The stirring was interrupted; the solid product settled, and the supernatant liquid was siphoned off, while maintaining the temperature at 109° C. A third treatment in fresh TiCl₄ (1 L of total volume) was repeated, keeping the mixture under agitation at 109° C. for 15 minutes, and then the supernatant liquid was siphoned off.

The solid was washed with anhydrous i-hexane five times (5×1.0 L) at 50° C. and one time (1.01) at room temperature

The solid was finally dried under vacuum, weighed, and analyzed.

Catalyst composition: Mg=12.5wt %; Ti=3.7wt %; I.D.=20.7 wt %.

The catalyst was used in the polymerization of propylene. Results are shown in Table 1.

### Example 2 and Comparative Examples 3-5

### Preparation of the Coloring Agent/Solid Catalyst Component Dry Mixture at Weight Ratio 0.2

Into a 50 cc recipient, 3 grams of the catalyst component prepared as described in Example 1 and 0.6 grams of Cu-phthalocyanine were introduced. The solids were mixed for 30 minutes and then discharged. Several aliquots of the mixture were tested at different times in the polymerization of propylene. Conditions and results are shown in Table 1.

### Examples 6-7 and Comparative Examples 8-9

### Preparation of the Coloring Agent/Solid Catalyst Component Dry Mixture at Weight Ratio 0.1

Into a 50 cc recipient, 3 grams of the catalyst component prepared as described in Example 1 and 0.3 grams of Cu-phthalocyanine were introduced. The solids were mixed for 60 minutes and then discharged. Several aliquots of the mixture were tested at different times in the polymerization of propylene. Conditions and results are shown in Table 1.

### Examples 10-12 and Comparative Example 13

### Preparation of the Coloring Agent/Solid Catalyst Component Dry Mixture at Weight Ratio 0.05

Into a 50 cc recipient, 3 grams of the catalyst component prepared as described in Example 1 and 0.15 grams of Cu-phthalocyanine were introduced. The solids were mixed for 120 minutes and then discharged. Several aliquots of the mixture were tested at different times in the polymerization of propylene. Conditions and results are shown in Table 1.

### Examples 14-16.

### Preparation of the Coloring Agent/Solid Catalyst Component Dry Mixture at Weight Ratio 0.025

Into a 10 cc recipient, 3 grams of the catalyst component prepared as described in Example 1 and 0.075 grams of Cu-phthalocyanine were introduced. The solids were mixed for 60 minutes and then discharged. Several aliquots of the mixture were tested at different times in the polymerization of propylene. Conditions and results are shown in Table 1.

TABLE 1

| | | | | | | | | Pig- |
|---|---|---|---|---|---|---|---|---|
| | Pig/Cat | Aging | Activity | XI | Yellow | Bulk | | ment |
| | Wt | Time | Kg/ | % | Index | Density | Tc | in PP |
| EX. | ratio | days | gcat(a) | wt | — | g/cm³ | ° C. | ppm |
| C1 | — | — | 50 | 98.6 | 1.4 | 0.46 | 113 | — |
| 2 | 0.2:1 | 1 | 40 | 98.4 | −61 | 0.48 | 121 | 6.3 |
| C3 | 0.2:1 | 11 | 31 | 98.7 | −65 | 0.44 | 121 | 8 |
| C4 | 0.2:1 | 24 | 19 | 98.4 | nd | 0.42 | nd | 13 |
| C5 | 0.2:1 | 30 | 11 | 98.2 | nd | 0.37 | nd | 22 |
| 6 | 0.1:1 | 1 | 41 | 98.5 | −27 | 0.47 | nd | 2.7 |
| 7 | 0.1:1 | 11 | 37 | 98.4 | −29 | 0.46 | nd | 3 |
| C8 | 0.1:1 | 24 | 23 | 98.6 | nd | 0.43 | nd | 5 |
| C9 | 0.1:1 | 30 | 17 | 98.3 | nd | nd | nd | 7 |
| 10 | 0.05:1 | 1 | 42 | 98.1 | −16 | 0.47 | nd | 1.2 |
| 11 | 0.05:1 | 11 | 38 | 98.4 | −18 | 0.47 | nd | 1.4 |
| 12 | 0.05:1 | 29 | 36 | 98.3 | −17 | 0.45 | nd | 1.6 |
| C13 | 0.05:1 | 35 | 29 | 98.7 | −13 | 0.45 | nd | 1.7 |
| 14 | 0.025:1 | 10 | 46 | 98.6 | nd | nd | nd | 0.5 |
| 15 | 0.025:1 | 23 | 46 | 98.4 | −3.5 | nd | nd | 0.5 |
| 16 | 0.025:1 | 60 | 44 | nd | nd | nd | nd | nd |

Nd = not determined

What is claimed is:

1. A process for the preparation of a propylene polymer containing a coloring agent, comprising the steps of:
(i) forming a solid dry mixture (a-b) of (a) a ZN catalyst component comprising Mg, Ti, halogen and an internal electron donor compound, and (b) a coloring agent comprising at least a pigment; wherein the mixture being in a weight ratio (b):(a) ranging from 0.01:1 to 0.4:1; and
(ii) feeding the mixture (a-b) to a polymerization reactor and operating the reactor under polymerization conditions to produce the propylene polymer,
wherein the process having the b:a weight ratio and a time in days elapsed between mixture formation and use in polymerization fall below the curve defined by the equation y=3+0.832x^{-1,17} wherein y is the time in days elapsed between mixture formation and use in polymerization and x is the (b):(a) weight ratio.

2. The process according to claim 1, wherein the ZN catalyst has a spherical regular morphology and obtained by reacting Ti-halides with precursors comprising adducts of formula MgCl₂(R¹OH)ₙ where R¹ is a C₁-C₈ alkyl group, and n is from 2 to 6.

3. The process according to claim 1, wherein, in the ZN catalyst component, the amount of Mg ranges from 8 to 30% and the amount of Ti ranges from 0.5 to 8% wt with respect to the total weight of solid catalyst component.

4. The process according to claim 3, wherein the electron donor compound is selected from esters, ethers, amines, silanes, carbamates and ketones or mixtures thereof.

5. The process according to claim 4, wherein the electron donor compound is selected from the group consisting of 1,3-diethers of formula (I) 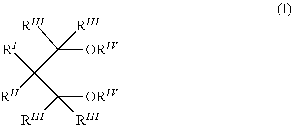
where R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups equal or different from each other, have the same meaning of R^{III} except that R^{IV} groups cannot be hydrogen.

6. The process according to claim 4, wherein the final amount of electron donor compound in the solid catalyst component ranges from 0.5 to 30% by weight.

7. The process according to claim 1, wherein the pigment is black or blue.

8. The process according to claim 7 wherein the pigment is Cu-Phthalocyanine.

9. The process according to claim 7, wherein the pigment is inorganic and selected from the group consisting of Ultramarine Blue and Carbon Black.

10. The process according to claim 1 wherein the coloring agent (b) is used in an amount such that the weight ratio (b):(a) ranges from 0.01:1 to 0.30:1.

11. The process according to claim 10, wherein the coloring agent is used in an amount such that the weight ratio (b):(a) ranges from 0.01:1 to 0.20:1.

12. The process according to claim 1 wherein the solid dry mixture is prepared using a first closed device equipped with internal rotating structures or a second closed rotating device wherein components a) and b) are mixed without the use of a liquid medium.

13. The process according to claim 1, wherein the mixture (a-b) is fed to a polymerization reactor together with an alkyl-Al compound selected from the group consisting of trialkyl aluminum compounds and optionally an external electron donor compound.

14. The process according to claim 13, wherein the external donor is present and selected from silicon compounds of formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms.

15. The process according to claim 1, wherein the amount of coloring agent in the final propylene polymer ranges from 0.3 to 10 ppm.
